(19) United States
(12) Patent Application Publication
(10) Pub. No.: US 2019/0278645 A1
(43) Pub. Date: Sep. 12, 2019

(54) LOG POST-PROCESSOR FOR IDENTIFYING ROOT CAUSES OF DEVICE FAILURE DURING AUTOMATED TESTING

(71) Applicant: Advantest Corporation, Tokyo (JP)

(72) Inventors: Linden HSU, San Jose, CA (US); Ben ROGEL-FAVILA, San Jose, CA (US); Bob COLLINS, San Jose, CA (US); Eddy CHOW, San Jose, CA (US); Michael JONES, San Jose, CA (US); Duane CHAMPOUX, San Jose, CA (US); Mei-Mei SU, San Jose, CA (US)

(21) Appl. No.: 15/916,126

(22) Filed: Mar. 8, 2018

(51) Int. Cl. G06F 11/07

(52) U.S. Cl. CPC G06F 11/079; G06F 11/0769; G06F 11/0778; G06F 11/0751

(57) ABSTRACT

A method for diagnosing a root cause of failure using automated test equipment (ATE) is disclosed. The method comprises identifying a failing device under test (DUT). Further, the method comprises opening a test program log associated with the failing DUT and determining a time of failure by parsing through the test program log to find an identifier and timestamp associated with the failure. Finally, the method comprises displaying the test program log in a window within a graphical user interface, wherein a relevant section of the test program log associated with the failure is displayed in the window.

### FIELD OF THE INVENTION

The present disclosure relates generally to the field of electronic device testing systems and more specifically to the field of electronic device testing equipment for testing devices under test (DUTs).

### BACKGROUND OF THE INVENTION

Automated test equipment (ATE) can be any testing assembly that performs a test on a semiconductor device or electronic assembly. ATE assemblies may be used to execute automated tests that quickly perform measurements and generate test results that can then be analyzed. An ATE assembly may be anything from a computer system coupled to a meter, to a complicated automated test assembly that may include a custom, dedicated computer control system and many different test instruments that are capable of automatically testing electronics parts and/or semiconductor wafer testing, such as system-on-chip (SOC) testing or integrated circuit testing. ATE systems both reduce the amount of time spent on testing devices to ensure that the device functions as designed and serve as a diagnostic tool to determine the presence of faulty components within a given device before it reaches the consumer.

One of the drawbacks with conventional ATE is that they typically only report pass/fail results. In other words, the ATE only reports whether one or more devices under test (DUTs) passed or failed the respective test being executed. The ATE is not configured to identify root causes of device failure that occur during qualification testing. In a typical testing environment, the technicians operating the ATE will need to identify the root cause of failure manually by collecting data logs and performing analysis on the logs manually. This approach is labor intensive, error prone and not scalable. It may also not yield the desired result since there may not be enough information available to the technicians to determine which data logs to analyze or how to find the root causes of device failure within the data logs.

### BRIEF SUMMARY OF THE INVENTION

Accordingly, a need exists for an ATE that automatically parses through detailed logs generated by the ATE during testing and provide relevant information to the user. Further, a need exists for a log post-processor tool that can sift through extensive log information and, based on information regarding the methodology by which the logs are generated, can extract meaningful information regarding root causes of device failure from within the logs.

In one embodiment, a method for diagnosing a root cause of failure using automated test equipment (ATE) is disclosed. The method comprises identifying a failing device under test (DUT). Further, the method comprises opening a test program log associated with the failing DUT and determining a time of failure by parsing through the test program log to find an identifier and timestamp associated with the failure. Finally, the method comprises displaying the test program log in a window within a graphical user interface, wherein a relevant section of the test program log associated with the failure is displayed in the window.

In one embodiment, a computer-readable storage medium having stored thereon, computer executable instructions that, if executed by a computer system cause the computer system to perform a method for diagnosing a root cause of failure using automated test equipment (ATE) is disclosed. The method comprises highlighting a failing device under test (DUT) and opening a test program log associated with the failing DUT in response to executing a script associated with a log post-processor. Further, the method comprises determining a time of failure by parsing through the test program log to locate an identifier and timestamp associated with the failure and displaying the test program log in a window within a graphical user interface, wherein a relevant section of the test program log associated with the failure is displayed in the window.

In another embodiment, a system for performing a method for diagnosing a root cause of failure using automated test equipment (ATE) is disclosed. The system comprises a memory comprising a test program and a log post-processor script stored on a tester operating system, a communicative interface operable to connect to one or more devices under test (DUTs) and a processor coupled to the memory and the communicative interface. The processor is configured to operate in accordance with the log post-processor script to: (a) execute the test program; (b) identify a failing device under test (DUT), wherein the failing DUT produces an error condition in response to executing the test program; (c) open a test program log associated with the failing DUT in response to executing the log post-processor script; (d) determine a time of failure by parsing through the test program log to find an identifier and timestamp associated with the failure; and (e) display the test program log in a window within a graphical user interface, wherein a relevant section of the test program log associated with the failure is displayed in the window.

The following detailed description together with the accompanying drawings will provide a better understanding of the nature and advantages of the present invention.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIGS. 1A, 1B, 1C, 1D, 1E and 1F illustrate the manner in which device failure is detected manually in accordance with an embodiment of the present invention.

FIG. 2 illustrates on-screen displays of the manner in which the log post-processor can present logs in graphical user interface (GUI) viewers to technicians in accordance with one embodiment of the present invention.

FIG. 3 illustrates the manner in which typing the name of the batch file at the command line is able to execute the log post-processor in accordance with one embodiment of the present invention.

FIG. 4 illustrates an on-screen display of the various parameters that the log post-processor may allow in accordance with one embodiment of the present invention.

FIG. 5 illustrates a tab of the log post-processor GUI that allows a user to designate file paths in accordance with one embodiment of the present invention.

FIG. 6 illustrates a tab of the log post-processor GUI that allows a user to designate advanced options pertaining to the GUI in accordance with one embodiment of the present invention.

FIG. 7 illustrates a tab of the log post-processor GUI that allows a user to designate options specific to the tester in accordance with one embodiment of the present invention.

FIG. 8 illustrates a tab of the log post-processor GUI that allows a user to view the results of the log post processing in accordance with one embodiment of the present invention.

FIG. 9 depicts a flowchart of an exemplary computer implemented process of using a log post-processor to determine the root cause of failure for a device under test (DUT) in accordance with an embodiment of the present invention.

FIG. 10 is a block diagram of an example of a tester system capable of executing the tester software and the log post-processor in accordance with embodiments of the present invention.

FIG. 11A is a schematic block diagram for an automated test equipment (ATE) apparatus on which embodiments of the concurrent test system can be implemented in accordance with one embodiment of the present invention.

FIG. 11B is a schematic block diagram of an exemplary software representation for the automated test system in accordance with one embodiment of the present invention.

FIG. 12 is a schematic block diagram of an exemplary software representation for the log post-processor of an automated test system in accordance with one embodiment of the present invention.

In the figures, elements having the same designation have the same or similar function.

### DETAILED DESCRIPTION OF THE INVENTION

Reference will now be made in detail to embodiments, examples of which are illustrated in the accompanying drawings. While the embodiments will be described in conjunction with the drawings, it will be understood that they are not intended to limit the embodiments. On the contrary, the embodiments are intended to cover alternatives, modifications and equivalents. Furthermore, in the following detailed description, numerous specific details are set forth in order to provide a thorough understanding. However, it will be recognized by one of ordinary skill in the art that the embodiments may be practiced without these specific details. In other instances, well-known methods, procedures, components, and circuits have not been described in detail as not to unnecessarily obscure aspects of the embodiments.

A Log Post-Processor for Identifying Root Causes of Device Failure During Automated Testing

In conventional testers, the diagnostic process in case of device failure is time-consuming and tedious because there are several steps an expert or technician needs to take in order to interpret the test logs generated by a tester to find the root cause of failure. Additionally, in some cases, conventional testers do not provide detailed test results at all. Instead, they simply provide pass/fail results. Moreover, because all testing protocols are unique, a technician or test engineer may not have the necessary information to sift through the various test logs to determine the root cause of failure.

Test throughput can usually be improved in a number of ways. One way of improving test throughput is by providing a tool that will automatically parse through detailed logs generated by a tester during testing and provide relevant information to the user. Further, test throughput can be improved by providing a log post-processor tool within the tester that can sift through extensive log information and, based on information regarding the methodology by which the logs are generated, can extract meaningful information regarding root causes of device failure from within the logs in real-time. The log post-processor of the present invention advantageously conserves time and labor resources during testing and, further, can be scaled to analyze results from one or more testers simultaneously. Instead of a human analyzing logs manually, embodiments of the present invention analyze the debug data in real-time, identify suspicious conditions and flag potential error-related conditions for a human or software to examine.

Embodiments of the present invention automatically identify root causes of failures during device testing by sifting through all the data generated by a tester to first identify test logs that relate to the failure. Most testers will generate numerous logs, e.g., data logs, snap logs, data capture logs, etc. in the course of testing, not all of which will be pertinent to debugging. The log post-processor will, therefore, be configured to identify the relevant test logs. For example, the identification may be based on naming conventions, e.g., the log post-processor may identify certain file names most commonly associated with critical data related to device failures.

Subsequently, the log post-processor of the present invention identifies areas of interest within the test logs that are generated. In other words, the log post-processor is configured to identify areas within the test logs that are most likely to contain information regarding the root cause of device failure.

Embodiments of the present invention are further configured to translate and correlate timestamps generated by the logs and further translate and correlate identifiers generated by the logs. For example, the log post-processor may be configured to extract timestamps associated with all error message identifiers from within the logs.

Additionally, embodiments of the present invention can be configured to perform rules checking using the data generated by the tester and adding any information collected from the test logs into a knowledge database. For example, the log post-processor may be configured to inspect a log generated by a DUT and perform rule checking on the test data generated by the DUT. The rules can be predetermined and programmed into the log post-processor script. Any new information obtained from the testing and rule checking can subsequently be added to a knowledge database.

Accordingly, embodiments of the present invention advantageously save time from performing test operations manually. Ordinarily, it would take a technician or test engineer several hours to diagnose failures by manually analyzing data logs generated by the testing. The log post-processor of the present invention can extract and provide all the information a technician would need to identify the failures within seconds or minutes of the test completing.

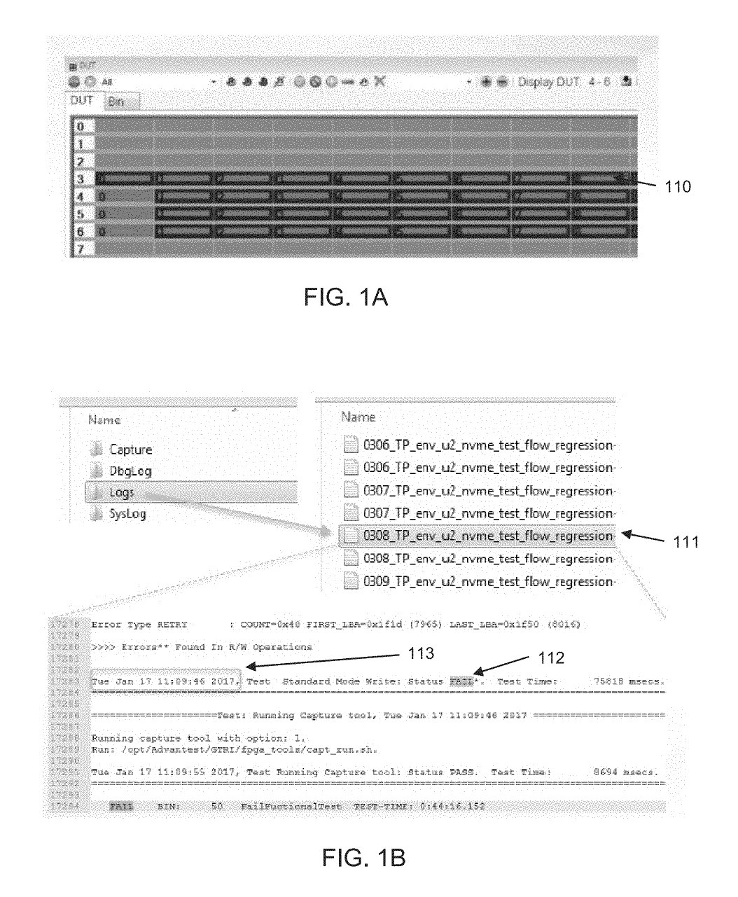

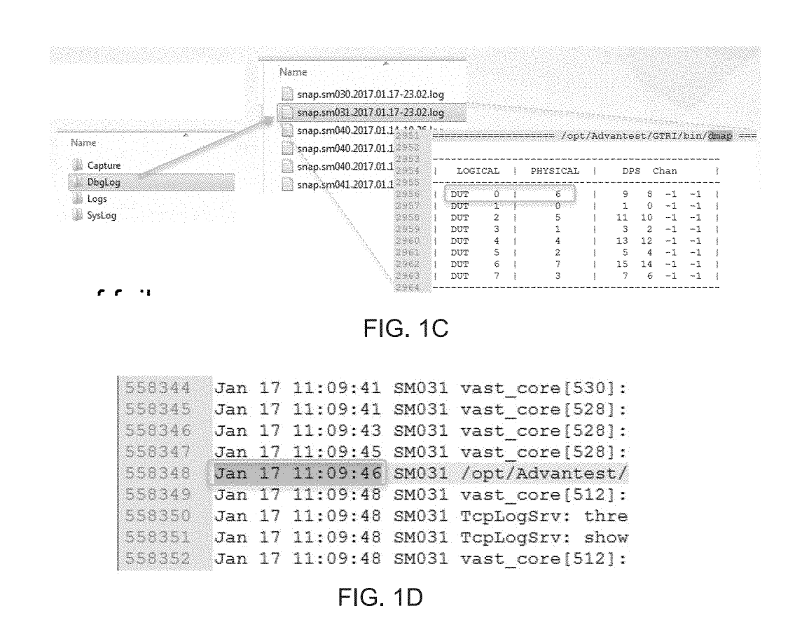

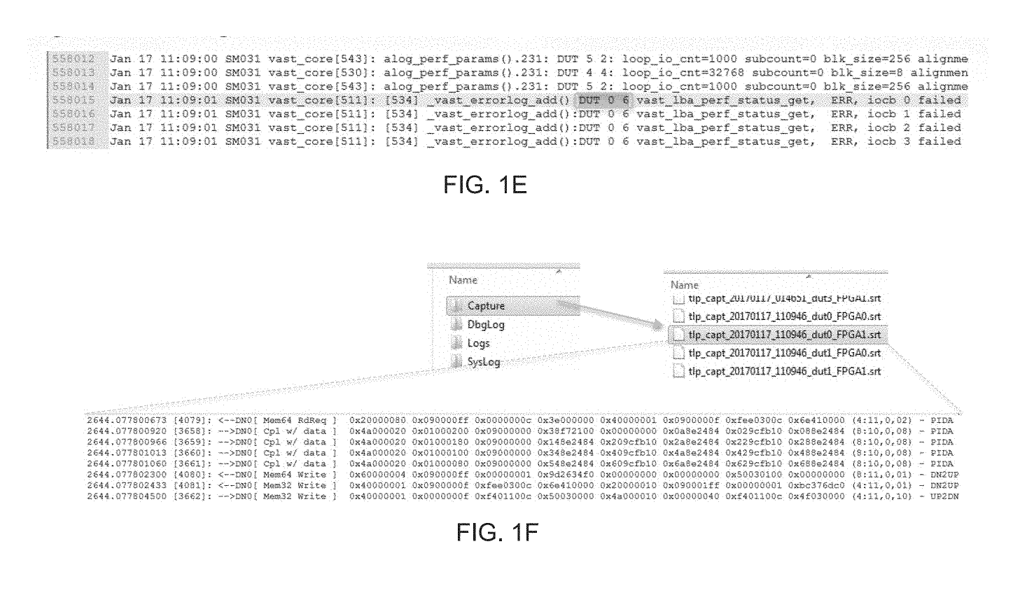

FIGS. 1A, 1B, 1C, 1D, 1E and 1F illustrate the manner in which device failure is detected manually in accordance with an embodiment of the present invention. As shown in FIG. 1A, a technician must first identify a failing DUT 110. Scripts can be configured to run on the tester or system controllers controlling the tester that generate test logs containing information for each of the devices tested.

FIG. 1B illustrates an on-screen display where the technician needs to open a test program log 111 for the failing DUT 110. Once the log is opened, the technician would need to find the failure point 112 in the test program log and determine the time 113 associated with the failure point 112. Thereafter, as shown in FIG. 1C, a technician may need to open another log related to debugging, e.g., a snap log to determine the logical to physical mapping of the DUT (also known as a device map). As shown in FIG. 1D, the technician would then go to the time of failure in the snap log (using the time identified from the test program log as shown in FIG. 1B) and inspect the snap log around the time of failure for further clues related to the failure.

If the devices under test, for example, are PCIe devices, the technician may then get the transaction layer packet (TLP) capture time from either the snap log or the test program log as shown in FIG. 1E. Transaction layer packets are exchanged between a host and a client (or between a tester and a device under test) using the PCIe protocol and the tester may, for example, capture these TLPs for further inspection and to collect failure related information. Information related to the TLPs may be collected in a TLP log, for example. As shown in FIG. 1F, once the TLP capture time is obtained from either the snap log or the test program log, the technician would open the pertinent TLP log (based on the time of failure and the DUT) and inspect the captured TLP in the TLP log. Note that there may be other types of information in the TLP log. Further, there may be other types of logs that contain pertinent information besides TLP logs.

As seen in FIGS. 1A-1F, in order to collect all the pertinent information related to device failure, a technician typically needs to manually browse through several logs and analyze all the relevant information. This is not only tedious but also time-consuming and error-prone. In one embodiment of the present invention, the log post-processor can be configured to advantageously sift through extensive log information and, based on the information regarding the manner in which the logs are generated, it can determine the type of failure information to look for within the logs.

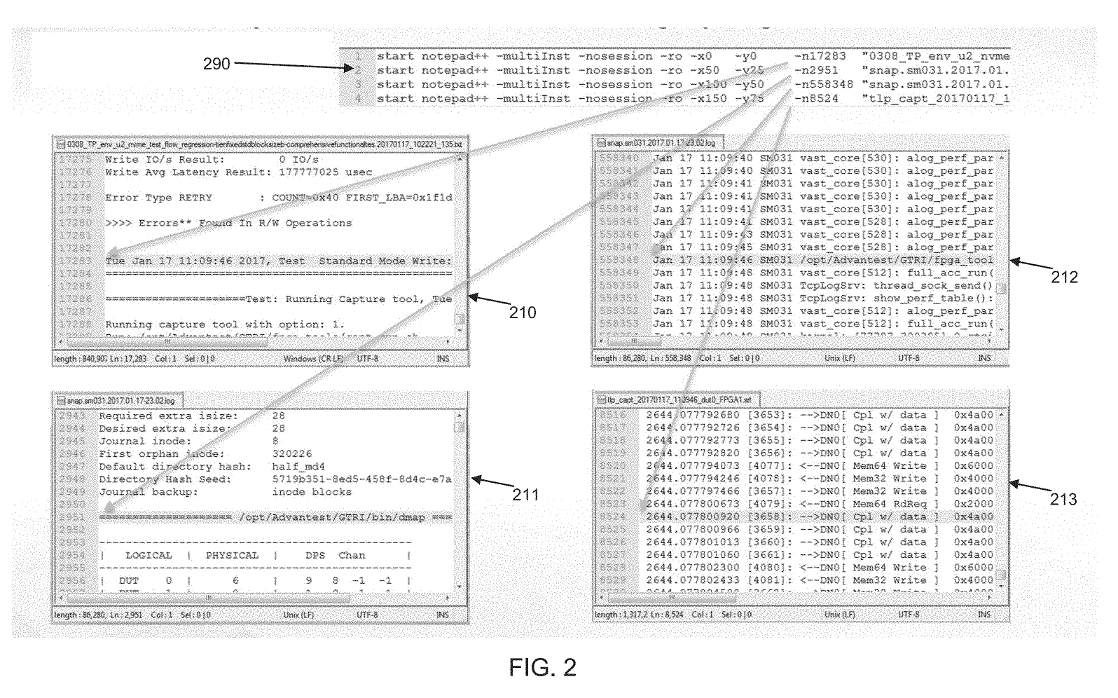

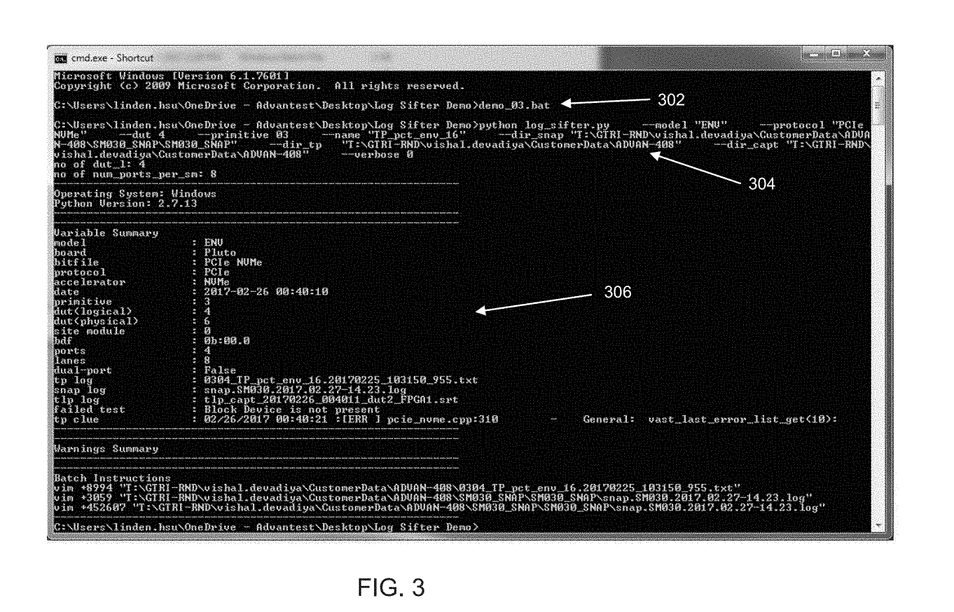

FIG. 2 illustrates on-screen displays of the manner in which the log post-processor can present logs in graphical user interface (GUI) viewers to technicians in accordance with an embodiment of the present invention. In one embodiment, the log post-processor comprises a script that is developed using a scripting language, e.g., the Python scripting language. In one embodiment, the log post-processor can generate a batch file (or shell script) that automatically brings up the logs in a GUI that directs users to the lines of interest.

In a typical embodiment, the log post-processor will provide details regarding one failing DUT at a time. In other words, the log post-processor will be executed separately for each instance of a failing DUT. However, it should be noted that in other embodiments the log processor may be configured to provide details regarding several DUTs at a time as well.

In a typical embodiment, the tester software responsible for interacting with and testing the DUTs would automatically execute the script or program associated with the log post-processor after the DUTs have been tested. Before executing the log post-processor however, the tester software will first wait for the test program to finish testing all the DUTs and for all the various log files generated by the DUTs during the testing process to be available. For each failing DUT, the log post processor will execute and automatically scan the various logs associated with the failing DUT (or DUTs) and determine the locations in each of the log files that contain information relevant to the failure. In order to determine the locations in each of the log files with relevant failure related information the log post-processor can, for example, be programmed to perform a keyword search of the log files. Note that each DUT being tested will generate various log files. Certain log files will be particular to a given DUT while other log files will contain information from several DUTs in the same log file.

The log post-processor will generate a batch file that can be executed to bring up windows displaying the various relevant log files, where each log file will have sections highlighted pertaining to the failing DUT. Note that the log post-processor will typically be configured to generate a separate batch file for each of the failing DUTs. The batch file may, for example, contain commands to a particular software, e.g., notepad++ (as shown in window 290 in FIG. 2). When the batch file is executed, the notepad application would be executed to display the various log files in GUI windows and highlight the relevant sections of each file.

For example, if the tester software determines that there are 20 failing DUTs, the log post-processor, in one embodiment, will be executed separately for each failing DUT automatically by the tester software. The log post-processor will then parse through the various log files, determine the locations of the pertinent information, and generate a separate batch file for each of the 20 failing DUTs. In other words, the log post-processor will generate 20 separate batch files. The user can then execute each of the batch files separately to obtain diagnostic information for each of the failing DUTs. For example, when the user runs the batch file 290 shown in FIG. 2, four separate instances of the notepad application are launched and relevant sections of the log files displayed therein are highlighted. In a different embodiment, the test program may be programmed to execute the batch files automatically subsequent to their generation so that the log files with relevant information are displayed on-screen automatically.

In one embodiment, instead of the tester software executing the log post processor automatically, a user can execute the log post-processor manually, e.g., by running the batch file (or shell script) associated with the log post processor from a command line. In one embodiment, the log post-processor may be executed using a batch file or shell script so that the program can be executed with options, e.g., parameters specifying file names, file locations etc. However, in one embodiment, the log post-processor can also be executed directly on the command line without using a batch file or script.

As shown in FIG. 2, the log post processor generates a batch file which, when executed, would open window 210 with the test program log (as discussed in connection with FIG. 1B) and highlight the failure point and the time associated with the failure point.

Further, the log post processor (subsequent to the execution of the batch file) is able to automatically bring up the snap log with the logical to physical mapping of the DUT in window 211 (as discussed in connection with FIG. 1C). The log post-processor (upon execution of the generated batch file) will also open a window 212 showing the snap log around the time failure for the technician to be able to inspect the snap log around the time of failure for further clues related to the failure (as discussed in connection with FIG. 1D). Finally, the log post-processor also brings up the pertinent TLP log (based on the time of failure and the DUT) in window 213 for the technician to inspect the captured TLP in the TLP log (as discussed in connection with FIG. 1F). There are other types of information that may be captured in a TLP log. For example, the TLP log may capture and inspect state-machine information, e.g., Link Training Status State Machine (LTSSM) packets for PCIe and Equalization information. As mentioned above, besides the TLP log, there may be other types of log that capture relevant information and the log post-processor is able to bring up those logs too with any related information. As noted above, there may be logs that are tied to a specific DUT, or there may be general logs that contain information regarding all the DUTs being tested. The log post-processor can be programmed to analyze all the relevant logs to find failure related information and generate a summary for the user to view using an on-screen display.

As mentioned above, in one embodiment, the log post-processor can, upon execution, automatically create a batch file (or shell script) that executes to bring up logs in viewers to lines of interest as shown in FIG. 2. The batch file generated by the log post-processor can be configured to execute automatically once the log post-processor has finished parsing through the various files or can be executed manually by the user. In one embodiment, the scripts that are executed within the batch file (or shell script) are prepared using the Python language for instance. In other embodiments, the shell script can be written using any other scripting language, e.g., Perl, Ruby etc. The Perl, Python or Ruby scripts.

As mentioned above, the log post-processor can be programmed to execute directly from the tester software or from the command line manually. Further, in one embodiment, the log post-processor itself can be prepared using a scripting language and be executed by running an associated script (e.g., a Unix shell script) using a command line interface. In one embodiment, the script associated with the log post-processor can be prepared using the Python language for instance. In other embodiments, the script can be written using any other scripting language, e.g., Perl, Ruby etc. The Perl, Python or Ruby scripts. The log post-processor program may also be developed with a language such as C, C++ etc. As mentioned above, the script for the log post-processor can be run as part of the batch file (for MS-DOS) or shell script (for Unix/Linux systems). In one embodiment, the file paths, directories and filenames that log post-processor searches to look for relevant logs can be programmed into the log post-processor script using regular expressions. A regular expression is a sequence of characters that define a search pattern.

The shell script associated with executing the log post-processor can be configured by first copying the script to a desired work folder. Subsequently, a technician or test engineer would need to edit a batch file or shell script associated with the execution of the log post-processor. Thereafter, the technician would run the shell script from a command window or terminal. In one embodiment, the log post-processor may take several parameters as input and, therefore, a batch file (or shell script) is convenient because it allows the user to input several parameters at the command line.

In one embodiment, the log post-processor can be programmed to collect all the information produced by running the shell script and interprets the information to determine the root cause of failure. In other words, instead of leaving it to the user to review all the information from the various logs to determine the root cause of failure manually, the log post-processor can be configured to collect and synthesize the information automatically and provide the user with a prediction as to the root cause of failure. In one embodiment, the log post-processor comprises a rule-checker that can parse through all the failure related information to identify some possible causes of the failure. In this embodiment, the user would still be allowed the option to view all the log files and review the log files manually to get further details regarding the problems. In one embodiment, the log post-processor is configured to display a summary of the test results in an on-screen display for the user to view.

In one embodiment, the technician would simply need to type the batch file name (associated with executing the log post-processor) at the MS-DOS (or Linux) command prompt in order for the log post-processor to run. Executing the log post-processor may then generate another batch file that is associated with bringing up the logs in viewers with relevant sections highlighted. In one embodiment, the batch file generated by the log post-processor can be configured to execute automatically once the log post-processor is done parsing through all the log files. In a different embodiment, the user can run this batch file generated by the log post-processor from the command line interface.

FIG. 3 illustrates the manner in which typing the name of the file at the command line is able to execute the log post-processor in accordance with one embodiment of the present invention. As shown in FIG. 3, the name of the file “demo_03.bat” is typed at command line 302. Thereafter, the file is executed and the Python script associated with the log post-processor is run at line 304. As shown in FIG. 3, running the Python script generates a variable summary 306 that includes, among other things, the files associated with the snap log, TLP log, and test program log.

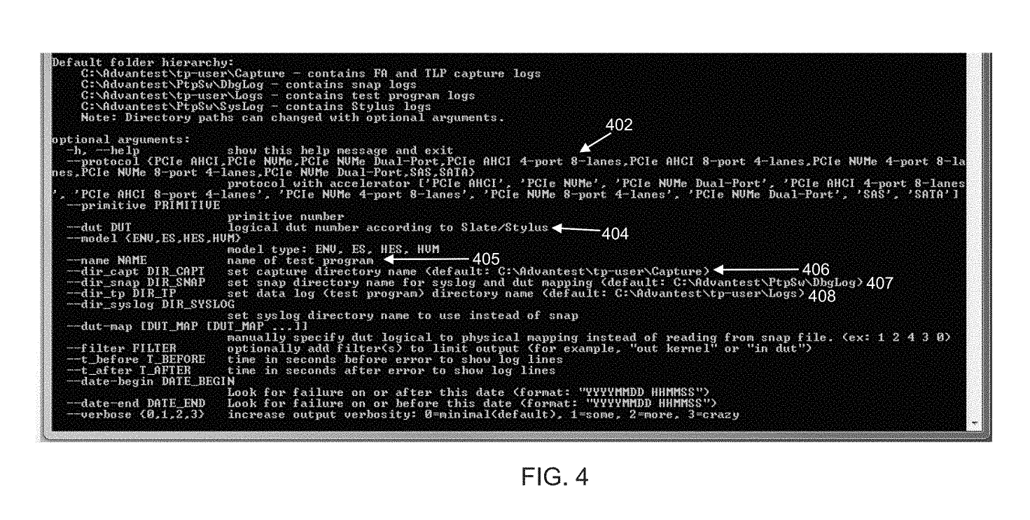

FIG. 4 illustrates an on-screen display of the various parameters that the log post-processor may allow in accordance with one embodiment of the present invention. For example, the “protocol” parameter 402 enables a user to choose the DUT protocol, e.g., PCIe, SAS, SATA, etc. The “dut” parameter 404 allows the user to specify the logical number of the DUT. The “name” parameter 405 allows the user to specify the name of the test program. The “dir_capt” parameter 406 allows the user to set the TLP capture directory name. The “dir_snap” parameter 407 allows the user to set the snap directory name. The “dir_tp” parameter 408 allows the user to set the test program directory name. Similarly, the other parameters shown in FIG. 4 allow the user to set various options to configure the log post-processor.

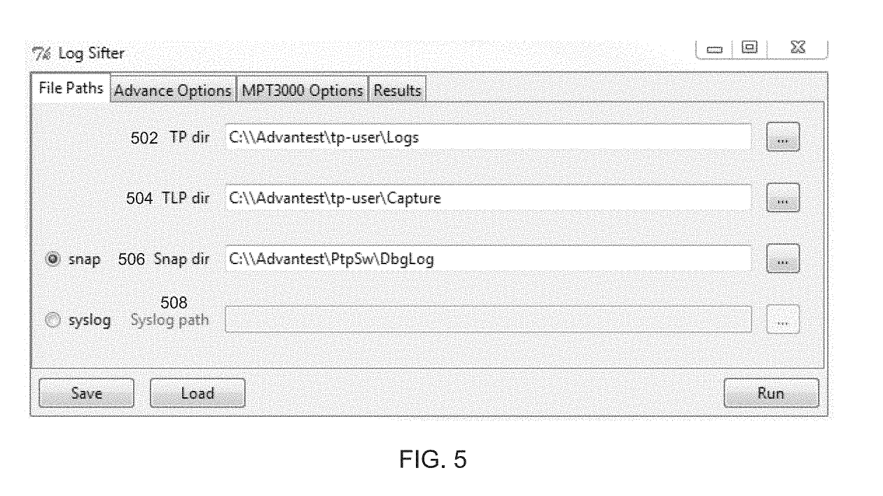

In one embodiment, the log post-processor can comprise a GUI intermediary between the user and the underlying script. FIG. 5 illustrates a tab of the log post-processor GUI that allows a user to designate file paths in accordance with one embodiment of the present invention. As shown in FIG. 5, the user can set the file paths for the test program directory (TP dir 502), the TLP directory for the TLP logs (TLP dir 504), the snap directory (Snap dir 506) and the syslog path 508. The TP dir points to where the user test program is located. The test program defines all the particulars pertaining to the test. For example, the test program will have details regarding when the DUT should be turned on, when it should be turned off, various initialization sequences, how to respond to device failures, etc. The results of all the various actions performed by the test program on one or more DUTs are logged in the TP log. The TP log is time stamped and provides a technician with a high level trace of the test execution.

The TLP directory points to where the capture logs are saved for the DUTs. In other words, the transaction layer packets pertaining to the protocol, e.g., PCIe are stored in the TLP directory. As mentioned above, the PCIe protocol communications using transaction layer packets. Further, the PCIe protocol may be implemented using an FPGA with a state machine that executes the protocol. The FPGAs can capture information during the protocol execution, including the TLPs, which can be used by a technician to figure out any problems associated with the test. This information is typically contained in a TLP capture log in the TLP directory. As mentioned above, the TLP log may contain state-machine related packets, e.g., LTSSM packets for PCIe or Equalization information. The TLP log can be inspected for example to determine if the state machine associated with the PCIe protocol is functioning correctly. For example, a technician would be able to review the TP log to determine if any particular state is out of order. Further, in one embodiment, during debugging, a technician may be able to inject errors intentionally into the TLP packets to cause failures to determine if the errors are captured by the FPGA and flagged correctly during post-processing.

It should be noted that the invention disclosed herein is not limited to simply capturing TLPs, LTSSM packets or equalization information. There may be many different types of information that are captured by the TLP and other logs that may be relevant to a technician.

The snap directory 506 points to where various software-level snap logs are saved. For example, a snap log would contain information regarding a logical to physical mapping of the DUT.

Finally, the syslog path 508 points to the location the system log is saved, e.g., a Linux system log. The syslog will typically contain more details or log information pertaining to the software that is controlling the hardware testing. For example, if a test is accidentally started while the DUT is missing, the software will need to be programmed to recognize that a device is missing and the manner in which to handle that exception. The syslog will typically contain a detailed trace of the test execution, including a software level trace.

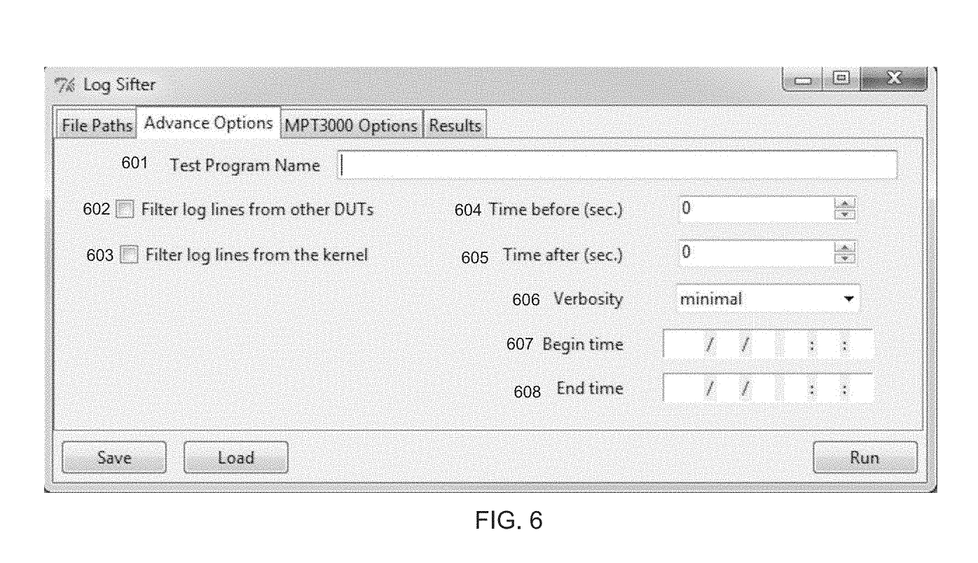

FIG. 6 illustrates a tab of the log post-processor GUI that allows a user to designate advanced options pertaining to the GUI in accordance with one embodiment of the present invention. Within the Advanced Options, GUI, the user can designate a test program name 601. The test program name will allow the user to choose the test program to be run. Note that the TP directory may contain more than one test program. The user can also filter out log lines that belong to other devices using checkbox 602. Further, the user can filter out log lines that are inserted by the kernel using option 603. The “Time before (sec)” field 604 allows the user to set the number of seconds before the failure that the log post-processor should start capturing log lines. The “Time after (sec)” field 605 allows the user to set the number of seconds after the failure that the log post-processor should stop capturing log lines. The Verbosity field 606 allows the user to select varying levels of messaging from the post-processing tool. The Begin Time field 607 and the End Time field 608 allows the user to search for a failure from the designated Begin Time to the designated End Time.

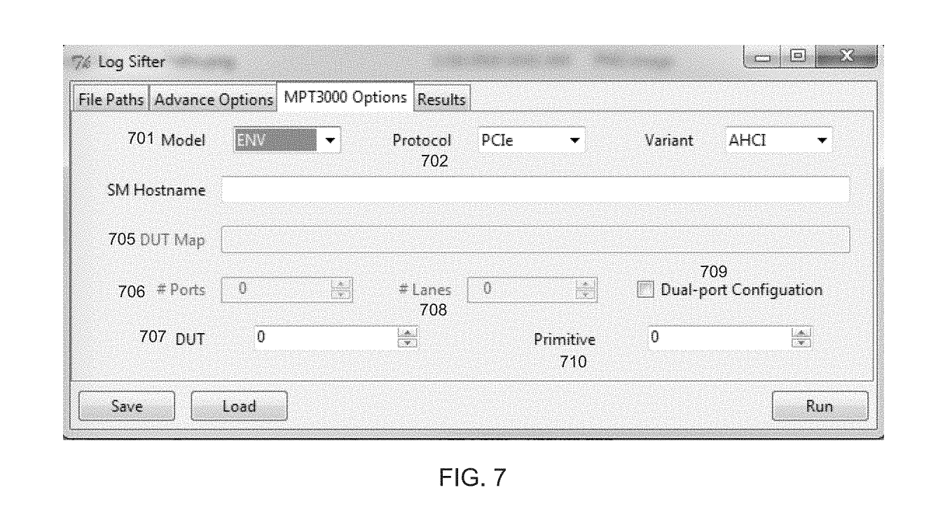

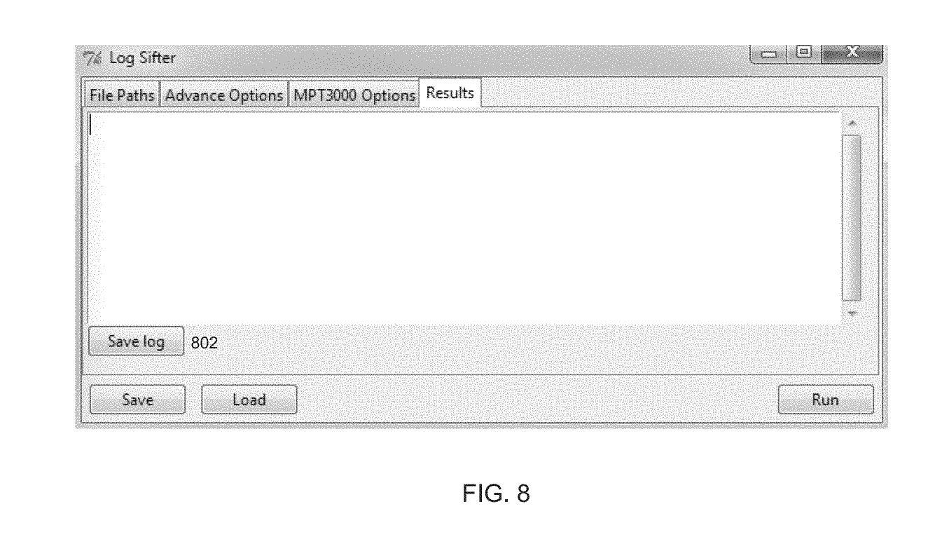

FIG. 7 illustrates a tab of the log post-processor GUI that allows a user to designate options specific to the tester in accordance with one embodiment of the present invention. Note that while FIG. 7 illustrates exemplary options associated with an exemplary tester MPT3000, embodiments of the present invention are not limited to any specific type of tester. Model number option 701 allows a user to designate the model number of the tester. The protocol field 702 allows the user to select the DUT protocol, e.g., SATA, SAS, PCIe, etc. The DUT map 705 field allows the user to specify the physical number to logical number mapping for the DUT. The number of ports field 706 allows the user to specify the number of ports per FPGA, wherein each FPGA in the tester can connect to and control one or more DUTs. The number of lanes field 708 allows the user to specify the number of lanes per device under test. The DUT field 707 allows the user to specify the device number to investigate.

FIG. 8 illustrates a tab of the log post-processor GUI that allows a user to view the results of the log post processing in accordance with one embodiment of the present invention. The results screen typically has a save option 802 that allows the user to save the log results to a knowledge database for future reference.

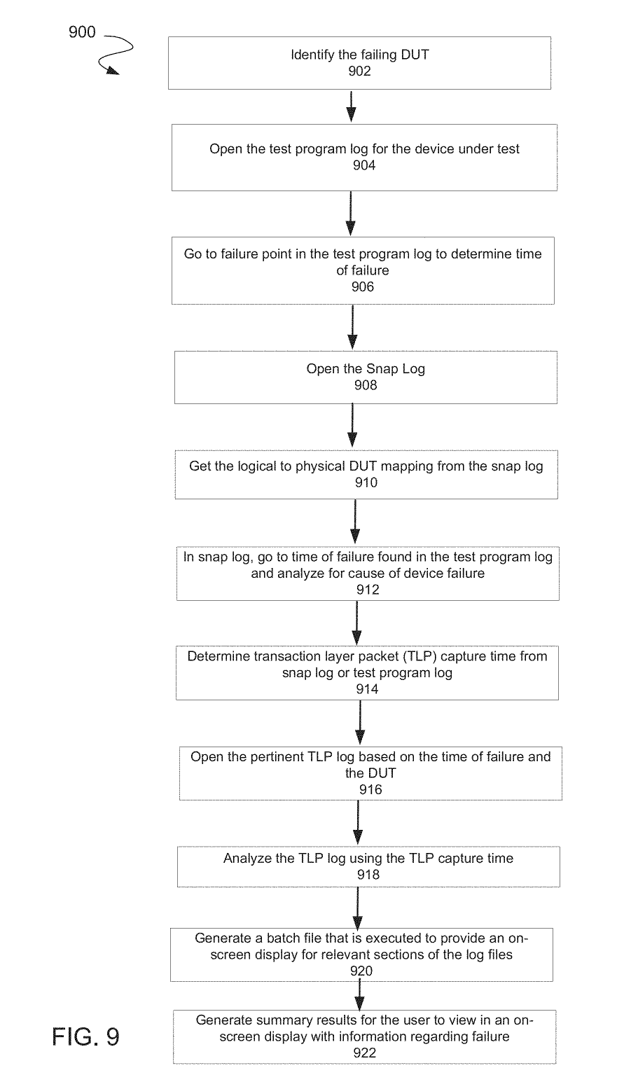

FIG. 9 depicts a flowchart 900 of an exemplary computer implemented process of using a log post-processor to determine the root cause of failure for a device under test (DUT) in accordance with an embodiment of the present invention.

At step 902, the tester software identifies the failing DUT and automatically executes the log post-processor. In one embodiment, the technician may have to manually identify the failing DUT and provide it as an input to the log post-processor using a command line interface prior to execution.

At step 904, the log post-processor, when executed, opens a test program (TP) log for the identified failing DUT.

At step 906, the log post-processor is programmed to go to the failure point in the TP log to determine the time of failure. The failure point may be identified on the basis of certain identifiers in the log that signal failure, e.g., a “FAILURE” message accompanied with a timestamp indicating the time of failure.

At step 908, the log post-processor can be configured to open the snap log. From the snap log, the log post-processor can determine the logical to physical mapping of the DUT (also known as a device map) at step 910. At step 912, the log post-processor can be configured to go to the time of failure in the snap log using the time identified from the test program log and analyze the snap log around the time of failure for possible causes of failure. In one embodiment, the log post-processor may use a rule-checker to analyze the snap log to determine possible root causes of failure.

At step 914, the log post-processor can be programmed to get the transaction layer packet (TLP) capture time from either the snap log or the test program log. For example, transaction layer packets are exchanged between a host and a client (or between a tester and a device under test) using the PCIe protocol and the tester may capture these TLPs for further inspection and to collect failure related information. Information related to the TLPs may be collected in a TLP log, for example. At step 916, once the TLP capture time is obtained from either the snap log or the test program log, the log post-processor would open the pertinent TLP log (based on the time of failure and the DUT). At step 918, the log post-processor can be configured to analyze the TLP log to ascertain a root cause of failure, e.g., the log post-processor may use a rule checker to determine the cause of failure.

At step 920, the log post-processor can be programmed to generate a batch file, which is configured to open various windows displaying the log files with relevant sections highlighted. This batch file can either be programmed to execute automatically after the log post-processor has finishing executing or can be executed manually by the user. For example, executing the batch file shown in window 290 in FIG. 2, can bring up various viewers with relevant sections of the log files highlighted for the user, e.g., window 210 with the test program log, windows 211 and 212 with the snap log and window 213 with the TLP log.

For example, the batch file generated at step 920 can be executed to open a window 212 showing the snap log around the time failure for the technician to be able to inspect the snap log around the time of failure for further clues related to the failure. In one embodiment, the log post-processor can highlight the relevant lines in the snap log to clearly indicate which lines in the snap log need to be inspected. In a different embodiment, an indicated above, the log post-processor can be programmed to automatically parse through the relevant lines in the log file and identify a possible cause of failure to the technician.

Further, by way of example, executing the batch file can also bring up the pertinent TLP log in window 213 for the technician to inspect the captured TLP in the TLP log. In a different embodiment, the log post-processor automatically parses through the relevant lines in the TLP log and identifies a possible cause of failure to the technician. Executing the batch file can also pop open a window with the TP log (e.g. window 210) for a user to examine the error related identifiers.

At step 922, the log post-processor is configured to generate summary results for all the failure-related information and display the results in an on-screen display for the user to view.

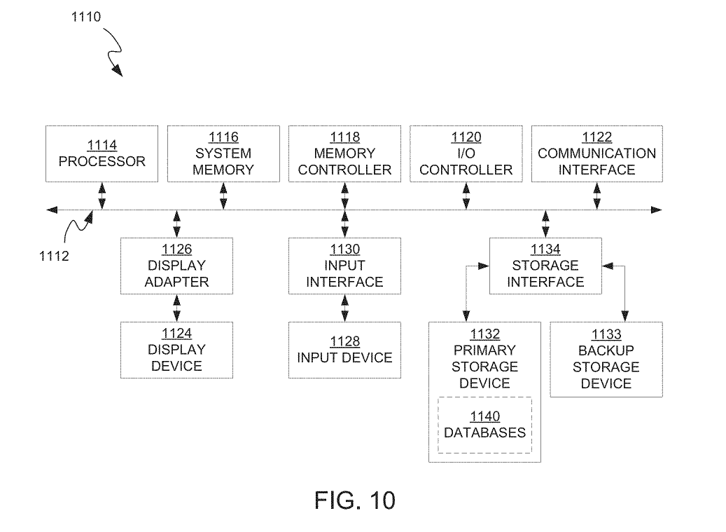

FIG. 10 is a block diagram of an example of a tester system capable of executing the tester software and the log post-processor in accordance with embodiments of the present invention. In an embodiment, system 110 controls execution of the tester software, performs testing of the DUTs, and also executes the log post-processor, which parses through the log files to determine failure related results. Tester control system 1110 broadly represents any single or multi-processor computing device or system capable of executing computer-readable instructions. Examples of control system 1110 include, without limitation, workstations, laptops, client-side terminals, servers, distributed computing systems, handheld devices, or any other computing system or device. In its most basic configuration, control system 1110 may include at least one processor 1114 and a system memory 1116.

Processor 1114 generally represents any type or form of processing unit capable of processing data or interpreting and executing instructions. In certain embodiments, processor 1114 may receive instructions from a software application or module. These instructions may cause processor 1114 to perform the functions of one or more of the example embodiments described and/or illustrated herein.

System memory 1116 generally represents any type or form of volatile or non-volatile storage device or medium capable of storing data and/or other computer-readable instructions. Examples of system memory 1116 include, without limitation, RAM, ROM, flash memory, or any other suitable memory device. Although not required, in certain embodiments control system 1110 may include both a volatile memory unit (such as, for example, system memory 1116) and a non-volatile storage device (such as, for example, primary storage device 1132).

Tester control system 1110 may also include one or more components or elements in addition to processor 1114 and system memory 1116. For example, in the embodiment of FIG. 10, control system 1110 includes a memory controller 1118, an input/output (I/O) controller 1120, and a communication interface 1122, each of which may be interconnected via a communication infrastructure 1112. Communication infrastructure 1112 generally represents any type or form of infrastructure capable of facilitating communication between one or more components of a computing device. Examples of communication infrastructure 1112 include, without limitation, a communication bus (such as an Industry Standard Architecture (ISA), Peripheral Component Interconnect (PCI), PCI Express (PCIe), or similar bus) and a network.

Memory controller 1118 generally represents any type or form of device capable of handling memory or data or controlling communication between one or more components of control system 1110. For example, memory controller 1118 may control communication between processor 1114, system memory 1116, and I/O controller 1120 via communication infrastructure 1112.

I/O controller 1120 generally represents any type or form of module capable of coordinating and/or controlling the input and output functions of a computing device. For example, I/O controller 1120 may control or facilitate transfer of data between one or more elements of control system 1110, such as processor 1114, system memory 1116, communication interface 1122, display adapter 1126, input interface 1130, and storage interface 1134.

Communication interface 1122 broadly represents any type or form of communication device or adapter capable of facilitating communication between example control system 1110 and one or more additional devices. For example, communication interface 1122 may facilitate communication between control system 1110 and a private or public network including additional control systems. Examples of communication interface 1122 include, without limitation, a wired network interface (such as a network interface card), a wireless network interface (such as a wireless network interface card), a modem, and any other suitable interface. In one embodiment, communication interface 1122 provides a direct connection to a remote server via a direct link to a network, such as the Internet. Communication interface 1122 may also indirectly provide such a connection through any other suitable connection.

Communication interface 1122 may also represent a host adapter configured to facilitate communication between control system 1110 and one or more additional network or storage devices via an external bus or communications channel. Examples of host adapters include, without limitation, Small Computer System Interface (SCSI) host adapters, Universal Serial Bus (USB) host adapters, IEEE (Institute of Electrical and Electronics Engineers) 1394 host adapters, Serial Advanced Technology Attachment (SATA) and External SATA (eSATA) host adapters, Advanced Technology Attachment (ATA) and Parallel ATA (PATA) host adapters, Fibre Channel interface adapters, Ethernet adapters, or the like. Communication interface 1122 may also allow control system 1110 to engage in distributed or remote computing. For example, communication interface 1122 may receive instructions from a remote device or send instructions to a remote device for execution.

As illustrated in FIG. 10, control system 1110 may also include at least one display device 1124 coupled to communication infrastructure 1112 via a display adapter 126. Display device 1124 generally represents any type or form of device capable of visually displaying information forwarded by display adapter 1126. Similarly, display adapter 1126 generally represents any type or form of device configured to forward graphics, text, and other data for display on display device 1124.

As illustrated in FIG. 10, control system 1110 may also include at least one input device 1128 coupled to communication infrastructure 1112 via an input interface 1130. Input device 1128 generally represents any type or form of input device capable of providing input, either computer- or human-generated, to control system 1110. Examples of input device 1128 include, without limitation, a keyboard, a pointing device, a speech recognition device, or any other input device.

As illustrated in FIG. 10, control system 1110 may also include a primary storage device 1132 and a backup storage device 1133 coupled to communication infrastructure 1112 via a storage interface 1134. Storage devices 1132 and 1133 generally represent any type or form of storage device or medium capable of storing data and/or other computer-readable instructions. For example, storage devices 1132 and 1133 may be a magnetic disk drive (e.g., a so-called hard drive), a floppy disk drive, a magnetic tape drive, an optical disk drive, a flash drive, or the like. Storage interface 1134 generally represents any type or form of interface or device for transferring data between storage devices 1132 and 1133 and other components of control system 1110.

In one example, databases 1140 may be stored in primary storage device 1132. Databases 1140 may represent portions of a single database or computing device or it may represent multiple databases or computing devices. For example, databases 1140 may represent (be stored on) a portion of control system 1110 or on connected network devices. Alternatively, databases 1140 may represent (be stored on) one or more physically separate devices capable of being accessed by a computing device, such as control system 1110 and/or portions of network architecture.

Continuing with reference to FIG. 10, storage devices 1132 and 1133 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 1132 and 1133 may also include other similar structures or devices for allowing computer software, data, or other computer-readable instructions to be loaded into control system 1110. For example, storage devices 1132 and 1133 may be configured to read and write software, data, or other computer-readable information. Storage devices 1132 and 1133 may also be a part of control system 1110 or may be separate devices accessed through other interface systems.

Many other devices or subsystems may be connected to control system 1110. Conversely, all of the components and devices illustrated in FIG. 10 need not be present to practice the embodiments described herein. The devices and subsystems referenced above may also be interconnected in different ways from that shown in FIG. 10. Control system 1110 may also employ any number of software, firmware, and/or hardware configurations. For example, the example embodiments disclosed herein may be encoded as a computer program (also referred to as computer software, software applications, computer-readable instructions, or computer control logic) on a computer-readable medium.

The computer-readable medium containing the computer program may be loaded into control system 1110. All or a portion of the computer program stored on the computer-readable medium may then be stored in system memory 1116 and/or various portions of storage devices 1132 and 1133. When executed by processor 1114, a computer program loaded into control system 1110 may cause processor 1114 to perform and/or be a means for performing the functions of the example embodiments described and/or illustrated herein. Additionally or alternatively, the example embodiments described and/or illustrated herein may be implemented in firmware and/or hardware.

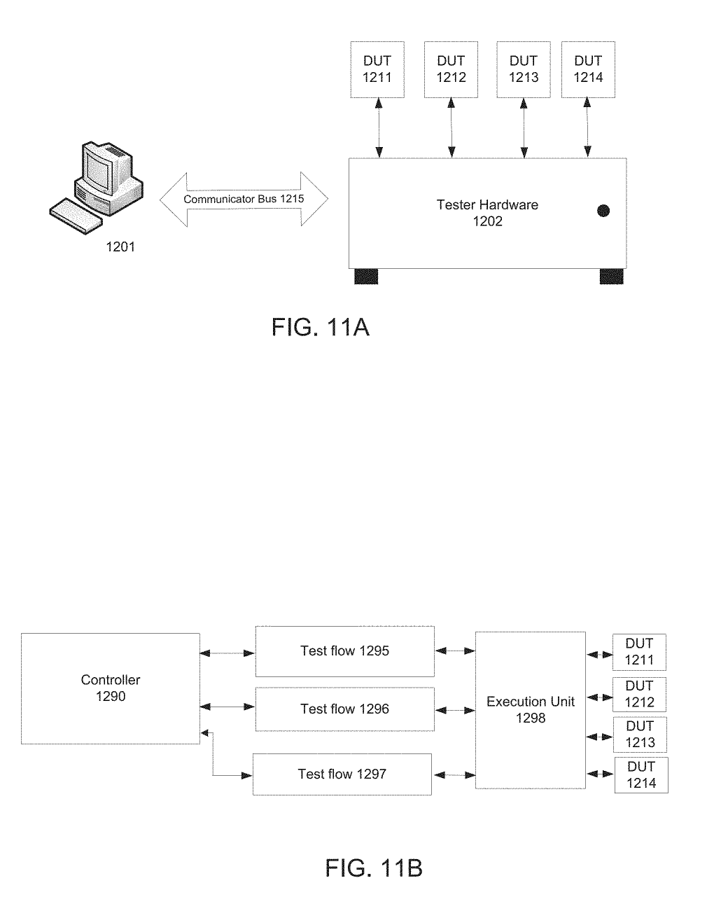

FIG. 11A is a schematic block diagram for an automated test equipment (ATE) apparatus on which embodiments of the concurrent test system can be implemented in accordance with one embodiment of the present invention. In one embodiment, the system controller 1201 comprises one or more linked computers. For example, testing systems such as Advantest Corporation's T2000 tester family, use a network of computers. In other embodiments, the system controller often comprises only a single computer. The system controller 1201 is the overall system control unit, and runs the software for the ATE that is responsible for accomplishing all the user-level testing tasks, including running the user's main test program. The test software running on the system controller 1201 can, for example, execute the log post-processor of the present invention once it has finished testing all the connected DUTs.

The communicator bus 1215 provides a high-speed electronic communication channel between the system controller and the tester hardware. The communicator bus can also be referred to as a backplane, a module connection enabler, or system bus. Physically, communicator bus 1215 is a fast, high-bandwidth duplex connection bus that can be electrical, optical, etc. System controller 1201 sets up the conditions for testing the DUTs 1211-1214 by programming the tester hardware through commands sent over the communicator bus 1215.

Tester hardware 1202 comprises the complex set of electronic and electrical parts and connectors necessary to provide the test stimulus to the devices under test (DUTs) 1211-1214 and measure the response of the DUTs to the stimulus, and compare it against the expected response.

A test program or test plan comprises all user-defined data and control flows that are necessary to perform a semiconductor device test on an ATE system. It typically runs on the system controller 1201. The main control flow in a test program, which dictates the sequence of individual tests to be applied to the DUTs, and the order in which the tests will be applied (which is dependent on the results of individual tests), is referred to as the test program flow.

FIG. 11B is a schematic block diagram of an exemplary software representation for the automated test system in accordance with one embodiment of the present invention. In one embodiment, in a typical testing scenario, the user's test plan, runs on controller module 1290 which is implemented in software on system controller 1201. Controller module 1290 uses the test plan to set up the various test flows for the test, e.g., test flow 1295, test flow 1296 and test flow 1297. The test plan then executes the user's test program flow on DUTS 1211, 1212, 1213 and 1214 using execution unit 1298. The results of the test program flow are communicated back to the controller module 1290 and, hence, to the user in accordance with the software running on the controller 1290. Based on these results, the software running on the controller module 1290 decides whether the DUTs have passed or failed the tests in the flow, how they should be graded and binned, when to progress to the next lot of DUTs, etc. The software can then execute the log post-processor to diagnose and determine the cause of failure for the failing DUTs.

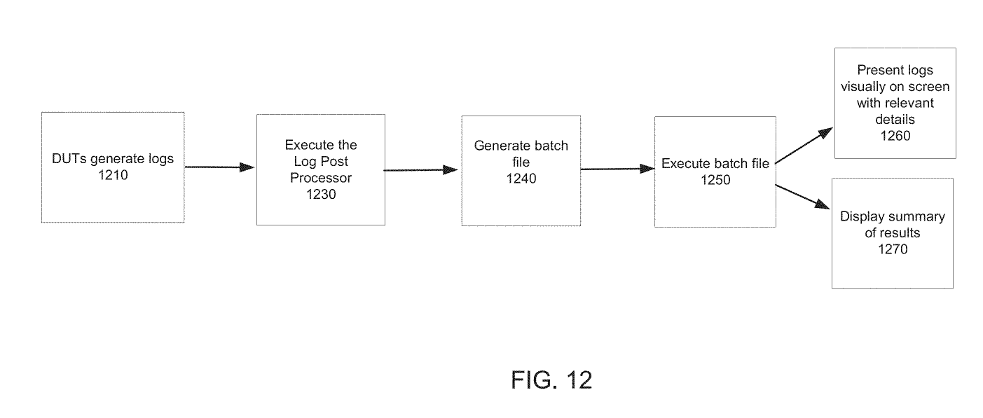

FIG. 12 is a schematic block diagram of an exemplary dataflow representation for the log post-processor of an automated test system in accordance with one embodiment of the present invention.

At block 1210, the DUTs generate several logs containing, among other things, results of the testing. At block 1230, the log post-processor can be executed, manually using a shell script or automatically from the tester software. The log post-processor parses through the various logs and determines the locations of interest in the various log files.

The log file generates a batch file at block 1240. The batch file can be executed at block 1250 to display the various log files with their relevant sections pertaining to the failure highlighted on-screen for the user. Subsequently, the logs are presented on screen for the user to view and inspect at block 1260. Also, the log post-processor can generate a summary of the results on the screen for a user to ascertain the root causes of failure.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

What is claimed is:

1. A method for diagnosing a root cause of failure using automated test equipment (ATE), the method comprising:
highlighting a failing device under test (DUT);
opening a test program log associated with the failing DUT in response to executing a script associated with a log post-processor;
determining a time of failure by parsing through the test program log to locate an identifier and timestamp associated with the failure; and
displaying the test program log in a window within a graphical user interface, wherein a relevant section of the test program log associated with the failure is displayed in the window.

2. The method of claim 1, further comprising:
opening a snap log, wherein the snap log comprises further information pertaining to the failure of the DUT, and wherein the snap log also contains information regarding a logical to physical mapping for the DUT;
obtaining a logical to physical mapping for the DUT from the snap log; and
using the time of failure from the test program log, analyze the snap log to determine a root cause of failure for the failing DUT.

3. The method of claim 2, further comprising:
displaying the snap log in a window within a graphical user interface, wherein a relevant section of the snap log associated with the time of failure is displayed in the window.

4. The method of claim 2, wherein the DUT executes the PCIe protocol.

5. The method of claim 3, further comprising:
determining a transaction layer packet (TLP) capture time from the snap log;
opening a TLP log associated with the failing DUT and the time of failure; and
using the TLP capture time, analyzing the TLP log to determine a root cause of failure for the failing DUT.

6. The method of claim 3, further comprising:
determining a transaction layer packet (TLP) capture time from the test program log;
opening a TLP log associated with the failing DUT and the time of failure; and
using the TLP capture time, analyzing the TLP log to further determine a root cause of failure for the failing DUT.

7. The method of claim 5, further comprising:
adding information pertaining to the root cause of failure to a knowledge database.

8. A computer-readable storage medium having stored thereon, computer executable instructions that, if executed by a computer system cause the computer system to perform a method for diagnosing a root cause of failure using automated test equipment (ATE), the method comprising:
highlighting a failing device under test (DUT);
opening a test program log associated with the failing DUT in response to executing a script associated with a log post-processor;
determining a time of failure by parsing through the test program log to locate an identifier and timestamp associated with the failure; and
displaying the test program log in a window within a graphical user interface, wherein a relevant section of the test program log associated with the failure is displayed in the window.

9. The computer-readable storage medium of claim 8, wherein the method further comprises:
opening a snap log, wherein the snap log comprises further information pertaining to the failure of the DUT, and wherein the snap log also contains information regarding a logical to physical mapping for the DUT;
obtaining a logical to physical mapping for the DUT from the snap log; and
using the time of failure from the test program log, analyze the snap log to determine a root cause of failure for the failing DUT.

10. The computer-readable storage medium of claim 9, wherein the method further comprises:
displaying the snap log in a window within a graphical user interface, wherein a relevant section of the snap log associated with the time of failure is displayed in the window.

11. The computer-readable storage medium of claim 9, wherein the DUT executes the PCIe protocol.

12. The computer-readable storage medium of claim 11, wherein the method further comprises:
determining a transaction layer packet (TLP) capture time from the snap log;
opening a TLP log associated with the failing DUT and the time of failure; and
using the TLP capture time, analyzing the TLP log to further determine a root cause of failure for the failing DUT.

13. The computer-readable storage medium of claim 11, wherein the method further comprises:
determining a transaction layer packet (TLP) capture time from the test program log;
opening a TLP log associated with the failing DUT and the time of failure; and
using the TLP capture time, analyzing the TLP log to determine a root cause of failure for the failing DUT.

14. The computer-readable storage medium of claim 12, wherein the method further comprises:
adding information pertaining to the root cause of failure to a knowledge database.

15. A system for performing a method for diagnosing a root cause of failure using automated test equipment (ATE), the system comprising:
a memory comprising a test program and a log post-processor script stored on a tester operating system;
a communicative interface operable to connect to one or more devices under test (DUTs);
a processor coupled to the memory and the communicative interface, the processor being configured to operate in accordance with the log post-processor script to:
execute the test program;
identify a failing device under test (DUT), wherein the failing DUT produces an error condition in response to executing the test program;
open a test program log associated with the failing DUT in response to executing the log post-processor script;
determine a time of failure by parsing through the test program log to find an identifier and timestamp associated with the failure; and
display the test program log in a window within a graphical user interface, wherein a relevant section of the test program log associated with the failure is displayed in the window.

16. The system of claim 15, wherein the processor is further configured to:
open a snap log, wherein the snap log comprises further information pertaining to the failure;
obtain a logical to physical mapping for the DUT from the snap log; and
use the time of failure from the test program log to analyze the snap log to determine a root cause of failure for the failing DUT.

17. The system of claim 16, wherein the processor is further configured to:
display the snap log in a window within a graphical user interface, wherein a relevant section of the snap log associated with the time of failure is displayed in the window.

18. The system of claim 16, wherein the DUT executes the PCIe protocol.

19. The system of claim 16, wherein the processor is further configured to:
determine a transaction layer packet (TLP) capture time from the snap log;
open a TLP log associated with the failing DUT and the time of failure; and
use the TLP capture time to analyze the TLP log to determine a root cause of failure for the failing DUT.

20. The system of claim 19, wherein the processor is further configured to:
add information pertaining to the root cause of failure to a knowledge database.
